(19) United States
(12) Patent Application Publication
(10) Pub. No.: US 2026/0348461 A1
(43) Pub. Date: Nov. 5, 2026

(54) POWERTRAIN ARCHITECTURE

(71) Applicant: Deere & Company, Moline, IL (US)

(72) Inventors: JOHN J. GALLEN, Waterloo, IA (US); MARK J. TIESZEN, Holland, IA (US); THOMAS G. ORE, Cedar Falls, IA (US)

(21) Appl. No.: 19/198,783

(22) Filed: May 5, 2025

(51) Int. Cl. F16H 37/08; F16H 37/02; F16H 57/02

(52) U.S. Cl. CPC F16H 37/084; F16H 2037/028; F16H 2037/0886; F16H 2057/02034; F16H 2057/02056

(57) ABSTRACT

A working machine includes a prime mover including a prime mover output. A mechanical variator has a variator input and a variator output. A direct drive gearset connects the prime mover output to the variator input. An auxiliary component may also be driven by the direct drive gearset. A planetary gearset is configured to receive a first input from the direct drive gearset and a variable second input from the variator output. A multi-speed transmission is configured to transmit an output drive from the planetary gearset to one or more drive wheels, the transmission including a low speed range, a high speed range and a reverse range. A controller is configured to control the mechanical variator to vary an advance speed of the working machine, and to control the multi-speed transmission to select between the low speed range, the high speed range and the reverse range.

### FIELD OF THE DISCLOSURE

The present disclosure relates to a powertrain architecture for a working machine.

### BACKGROUND

Working machines of this type may for example include a compact utility tractor. Other examples include compact utility vehicles.

Various powertrain architectures have been proposed for such working machines. Especially in the case of electrically powered working machines such machines often use multiple electric machines to drive the various components of the working machine.

### SUMMARY OF THE DISCLOSURE

In one aspect the current disclosure provides a powertrain architecture using one prime mover to drive both the drivetrain and major auxiliary components of the working machine.

In one embodiment the working machine includes a main frame and a plurality of ground engaging units for supporting the main frame from a ground surface. A prime mover includes a prime mover output. The prime mover includes a single electric machine. A mechanical variator has a variator input and a variator output. A direct drive gearset connects the prime mover output to the variator input and rotates at a speed fixed in proportion to a rotational speed of the prime mover. A planetary gearset is configured to receive a first input from the direct drive gearset and a variable second input from the variator output, and to provide an output drive. A multi-speed transmission is configured to transmit the output drive from the planetary gearset to one or more of the ground engaging units to propel the working machine across the ground surface, the transmission including a low speed range, a high speed range and a reverse range. A controller is operably connected to the mechanical variator and the multi-speed transmission and configured to control the mechanical variator to vary an advance speed of the working machine, and to control the multi-speed transmission to select between the low speed range, the high speed range and the reverse range.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view of a working machine in the form of a compact utility tractor.

FIG. 2 is a schematic diagram of the powertrain architecture of the working machine.

FIG. 3 is a schematic diagram of a control system for the working machine.

FIG. 4 is an external perspective view of the powertrain.

FIG. 5 is a graphical display of the efficiency of the powertrain in the low range and the high range as a function of ground speed of the vehicle.

FIG. 6 is a graphical display of the transmission output torque of the powertrain in the low range and the high range as a function of ground speed of the vehicle

### DETAILED DESCRIPTION

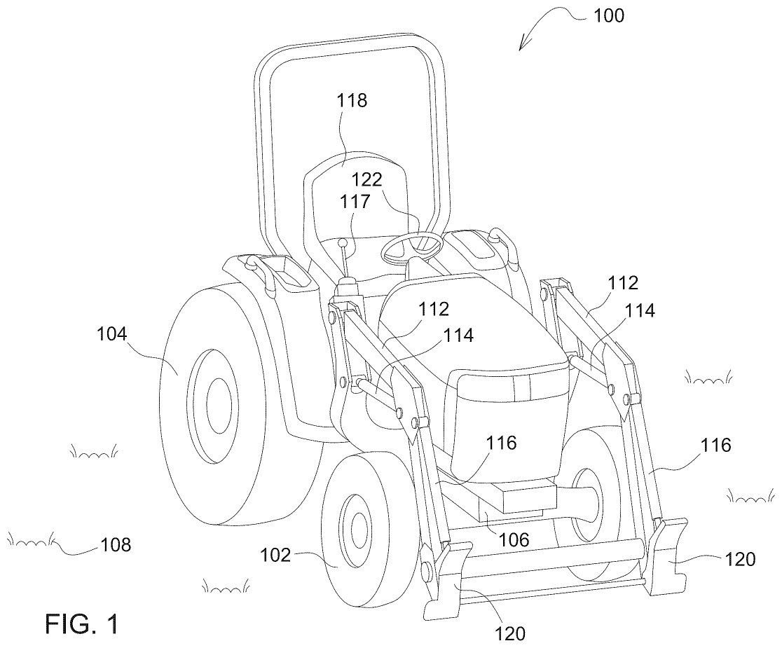

FIG. 1 shows a working machine 100 in the form of a compact utility tractor 100, having front wheels 102 and rear wheels 104 supporting a main frame 106. The front and rear wheels 102, 104 may be referred to as a plurality of ground engaging units 102, 104 for supporting the main frame 106 from a ground surface 108. The ground engaging units could also be tracked ground engaging units.

The working machine 100 is equipped with a boom 112 operated by hydraulic lifting cylinders 114 for raising a lowering a bucket or other working implement (not shown) connected to a quick attach bracket 120 pivotally connected to a front end of the boom 112. A plurality of tilt cylinders 116 pivot the quick attach bracket 120 and any attached working implement relative to the boom 112.

An operator sits in an operator's seat 118 and controls the working machine 100 via various operator controls such as 117. The operator steers the working machine 100 via a steering wheel 122 which steers the front wheels 102.

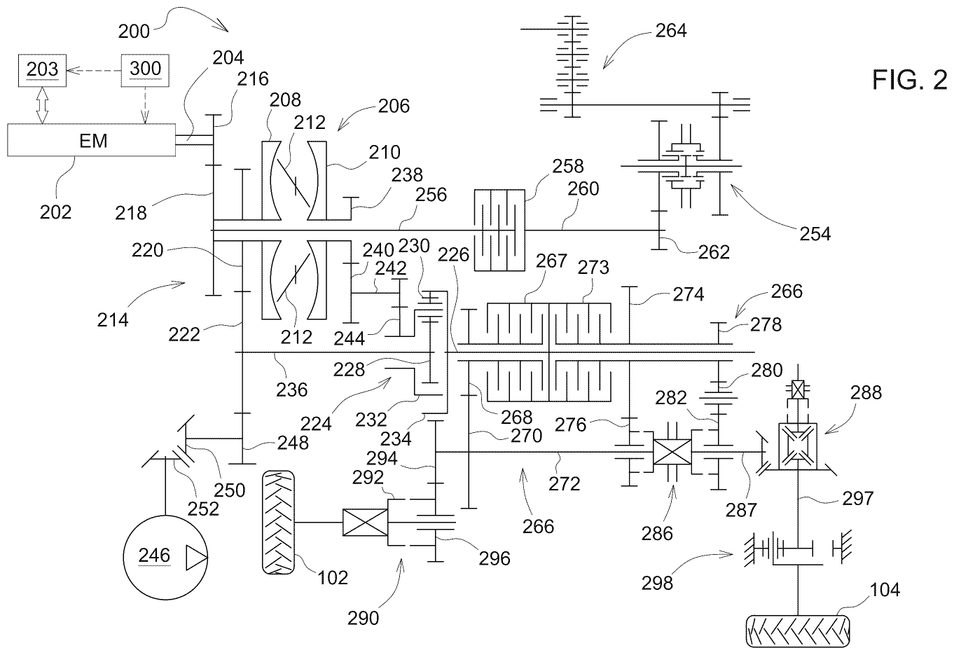

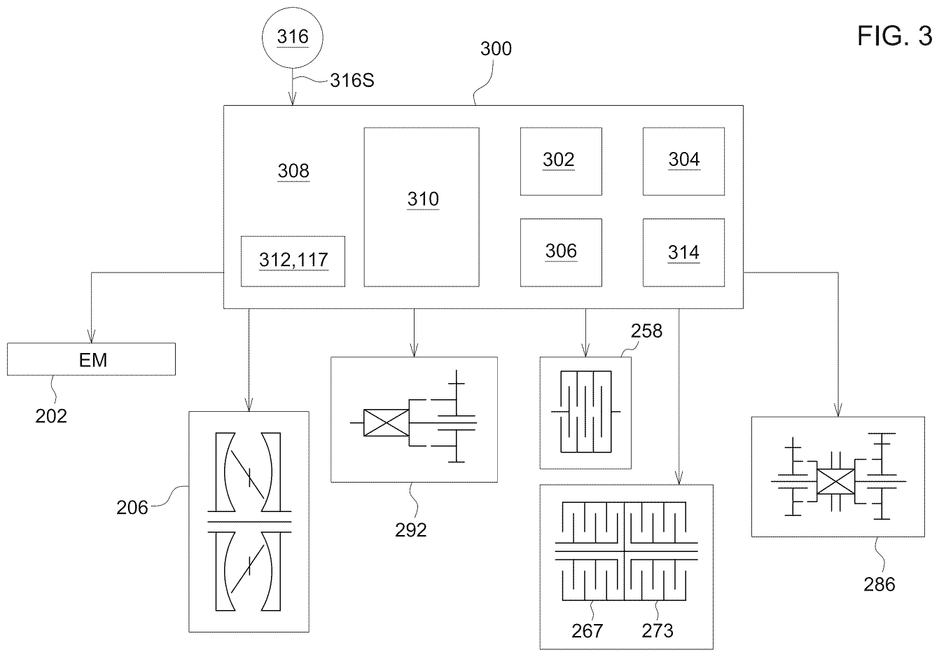

FIG. 2 schematically illustrates a powertrain 200 of the working machine 100. The powertrain 200 includes a prime mover 202 having a prime mover output 204. The prime mover 202 includes an electric machine. In some embodiments the prime mover 202 is a single electric machine, which is the only electric machine 202 serving as the sole prime mover 202 for the working machine 100. Electric machine 202 may draw power from and transfer excess power to a battery or other storage device 203 under control from a controller 300 further described below with regard to FIG. 3.

In other embodiments the working machine 100 may include multiple prime movers.

The powertrain 200 further includes a variator 206 having a variator input 208 and a variator output 210. In one embodiment the variator 206 may be a mechanical variator. A mechanical variator uses physical components like belts, pulleys, rollers and the like to change speed ratio. In some embodiments the mechanical variator is a toroidal CVT.

A direct drive gearset 214 is directly driven by the prime mover and rotates at a speed fixed in proportion to a rotational speed of the prime mover 202. The direct drive gearset 214 includes gears 216, 218, 220 and 222.

Gear 216 is attached to prime mover output 204 and turns gear 218 which is directly attached to variator input 208.

A planetary gearset 224 is configured to receive a first input from the direct drive gearset 214 and a variable second input from the variator output 210, and to provide an output drive 226. The planetary gearset 224 includes a sun gear 228, a plurality of planet gears 230 carried by a carrier 232, and a ring gear 234.

The gear 222 of the direct drive gearset 214 drives shaft 236 which is directly connected to the sun gear 228 to provide the first input to the planetary gearset 224 from the direct drive gearset 214.

The variator output 210 is attached to a gear 238 which drives gear 240 mounted on shaft 242 which drives gear 244 which drives the carrier 232 to provide the variable second input from the variator output 210 to the planetary gearset 224.

By combining the variator 206 and the planetary gearset 224 the working vehicle 100 can be operated at very low advance speeds, even at a zero advance speed, without the need for continuously slipping a clutch between the prime mover and the ground engaging wheels.

At least one auxiliary component is driven by the direct drive gearset 214. In one embodiment the auxiliary component may be a hydraulic pump 246 for providing pressurized hydraulic fluid to a hydraulic system of the working machine 100 for powering various hydraulic actuators of the working machine 100. As seen in FIG. 2 the hydraulic pump 246 may be driven by a gear 248 engaging gear 222 and further engaging gears 250 and 252 which drive pump 246. The pump gear drive may drive multiple hydraulic pumps for powering various hydraulic actuators of the working vehicle 100.

As further shown in FIG. 2, the auxiliary component may be a power take-off (PTO) 254. A shaft 256 attached to gear 218 of direct drive gearset 214 is connected through a PTO clutch 258 to a further shaft 260 and gear 262 which drive the power take-off 254. The power take-off 254 drives a further PTO gearset 264 that provides multiple power take-off outputs.

A multi-speed transmission 266 is configured to transmit the output drive 226 from the planetary gearset 224 to one or more of the ground engaging units 102, 104 to propel the working machine 100 across the ground surface 108, the transmission 266 including a low speed range, a high speed range and a reverse range.

The output drive 226 is connected by a first clutch 267 to a low range gearset including gears 268 and 270. The gear 270 is mounted on a direct drive shaft 272. The output drive 226 is connected by a second clutch 273 to a high range gearset including gears 274 and 276. The second clutch 273 also connects the output drive 226 to a reverse gearset including gears 278, 280 and 282. Gears 274 and 278 are both mounted on intermediate shaft 284 on the output side of second clutch 273.

A synchronizer 286 selectively couples either the high range gearset 274, 276 or the reverse drive gearset 278, 280, 282 with a drive shaft 287. The drive shaft 287 is connected through a rear differential 288 and drive axle 297 with the rear wheels 104. An emergency/parking brake 298 may engage the drive axle 297 going to one or both of the rear wheels 104.

A front drivetrain 290 includes a further clutch 292 and gears 294 and 296, via which the front wheels 102 may also be selectively driven from the direct drive shaft 272.

A controller 300 is operably connected to mechanical variator 206 and the multi-speed transmission 266 and configured to control the mechanical variator 206 to vary an advance speed of the working machine 100, and to control the multi-speed transmission 266 to select between the low speed range, the high speed range and the reverse range. The details of the controller 300 and the related control system are shown in FIG. 3.

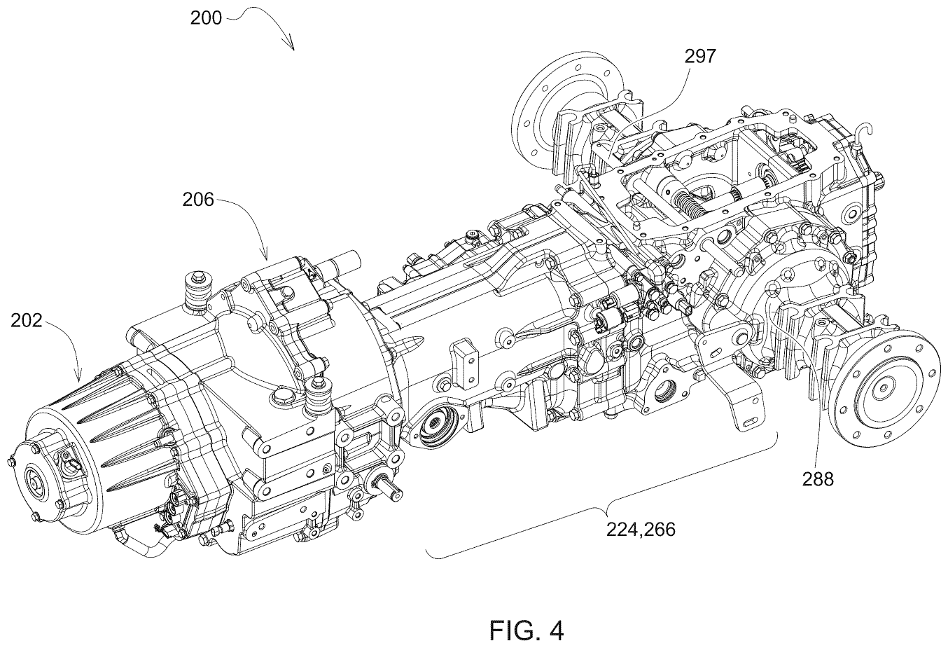

FIG. 4 is an external perspective view of the assembled powertrain 200 with the location of the major components such as the prime mover 202, the variator 206, the combined planetary gearset 224 and multi-speed transmission 266, and the rear differential 288 indicated. The powertrain architecture of powertrain 200 as disclosed herein provides a particularly compact arrangement which allows for the efficient and economical packaging and location of the powertrain 200 on the main frame 106 of working machine 100, especially when the prime mover 202 is an electric machine 202 and the electric machine 202 is the one and only one electric machine 202 which serves as the prime mover of the working machine 100.

### The Control System of FIG. 3

As schematically illustrated in FIG. 3, the working machine 100 includes a control system including the controller 300. The controller 300 may be part of the machine control system of the working machine 100, or it may be a separate control module. The controller 300 may be mounted in the operator's cab adjacent controls 117 and seat 118. The controller 300 is configured to receive as input signals the various operational parameters typically measured for such a working machine. The signals transmitted from the various sensors to the controller 300 are schematically indicated in FIG. 3 by lines connecting the sensors to the controller with an arrowhead indicating the flow of the signal from the sensor to the controller 300. For example, a vehicle speed sensor 316 may monitor a ground speed of the working vehicle 100 and provide a ground speed signal 316S to the controller 300.

Similarly, the controller 300 will generate control signals for controlling the operation of the various actuators, which control signals are indicated schematically in FIG. 3 by lines connecting the controller 300 to the various actuators with the arrow indicating the flow of the command signal from the controller 300 to the respective actuator. It will be understood that the various actuators as disclosed herein may be hydraulic motors or may be hydraulic piston-cylinder units and that the electronic control signals from the controller 300 will actually be received by electro-hydraulic control valves associated with the actuators and the electro-hydraulic control valves will control the flow of hydraulic fluid to and from the respective hydraulic actuators to control the actuation thereof in response to the control signal from the controller 300. In the context of the powertrain 200, the controller 300 will send control signals to electro-hydraulic control valves associated with hydraulic actuators configured to operate the PTO clutch 258, the first clutch 267, the second clutch 273, the synchronizer 286 and the further clutch 292. The controller 300 will also send control signals to control the adjustment of the variator 206 and the operation of the electric machine 202.

Controller 300 includes or may be associated with a processor 302, a computer readable medium 304, a data base 306 and an input/output module or control panel 308 having a display 310. An input/output device 312, such as a keyboard, joystick or other user interface, is provided so that the human operator may input instructions to the controller. The input/output device 312 may include the previously described operator input actuator 117 in the form of a joystick. It is understood that the controller 300 described herein may be a single controller having all of the described functionality, or it may include multiple controllers wherein the described functionality is distributed among the multiple controllers.

Various operations, steps or algorithms as described in connection with the controller 300 can be embodied directly in hardware, in a computer program product 314 such as a software module executed by the processor 302, or in a combination of the two. The computer program product 314 can reside in RAM memory, flash memory, ROM memory, EPROM memory, EEPROM memory, registers, hard disk, a removable disk, or any other form of computer-readable medium 304 known in the art. An exemplary computer-readable medium 304 can be coupled to the processor 302 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

### Modes of Operation

As noted the controller 300 is configured to control the variator 206 to vary an advance speed of the working machine 100, and to control the multi-speed transmission 266 to select between the low speed range, the high speed range and the reverse range. The following description will begin with a forward advancing operation of the working machine 100 at relative low ground speeds with the powertrain operating in the low speed range.

In one embodiment the system is configured such that the prime mover 202 operates at a relatively constant maximum or optimum speed, with all variation of advance speed being accomplished by adjustment of the position of the variator 206. In another embodiment, additional adjustment of advance speed can be provided by adjustment of the operating speed of the prime mover 202. The following description is based on the first embodiment wherein the prime mover 202 operates at a relatively constant maximum or optimum speed, with all variation of advance speed being accomplished by adjustment of the position of the variator 206.

Motive power flows from the prime mover 202 to the transmission 266 in a bifurcated path through the direct drive gearset 214 and the variator 206, with the two power flows being combined by the planetary gearset 224 and output to the output drive 226 and the direct drive shaft 272. The first power path from the prime mover 202 to the sun gear 228 of the planetary gearset 224 flows through gear 216, gear 218, gear 220, gear 222 and shaft 236. Assuming the prime mover 202 is operating at a fixed speed the input to the sun gear 228 will be at a corresponding fixed speed dependent upon the various intervening gear ratios. The second and variable power path from the prime mover 202 to the carrier 232 of the planetary gearset 224 flows through gear 216, gear 218, variator input 208, variator output 210, gear 238, gear 240, shaft 242 and gear 244 which drives the carrier 232. The input speed to the carrier 232 is variable based on adjustment of the variator 206. The planetary gearset 224 combines the fixed speed input to sun gear 228 and the variable speed input to carrier 232, providing a variable combined output speed to ring gear 234 and output drive 226.

Assuming that the transmission 266 is in the low speed range, the first clutch 267 is engaged and the second clutch 273 is open. Power from output drive 226 flows through the first clutch 267 and gears 268 and 270 to direct drive shaft 272 which directly drives shaft 287 to drive the rear wheels 104 in a forward direction. The forward advance speed is varied by the controller 300 directing the variator 206 to adjust the speed ratio between the variator input 208 and the variator output 210.

When the controller 300 determines that the advance speed has increased to a value such that it is desirable to shift into the high speed range, the controller 300 will direct the synchronizer 286 first to move into a high range position wherein the gear 276 is coupled to the direct drive shaft 272. Then the controller 300 will direct the first clutch 267 to disengage and the second clutch 273 to engage, so that power from the output drive 226 is transferred through second clutch 273 to gear 274, then gear 276 to the direct drive shaft 272. Once again, the forward advance speed in the high speed range is varied by the controller 300 directing the variator 206 to adjust the speed ratio between the variator input 208 and the variator output 210.

When the controller 300 detects that the advance speed, while operating in the high speed range, has dropped to a value such that it is desirable to shift back into the low speed range, the above process is reversed. Before shifting down into the low speed range, the controller 300 will direct the second clutch 273 to disengage, the synchronizer 286 to move back to a neutral position, then the first clutch 267 to engage, so that forward drive is again being accomplished via the low speed gearset 268, 270.

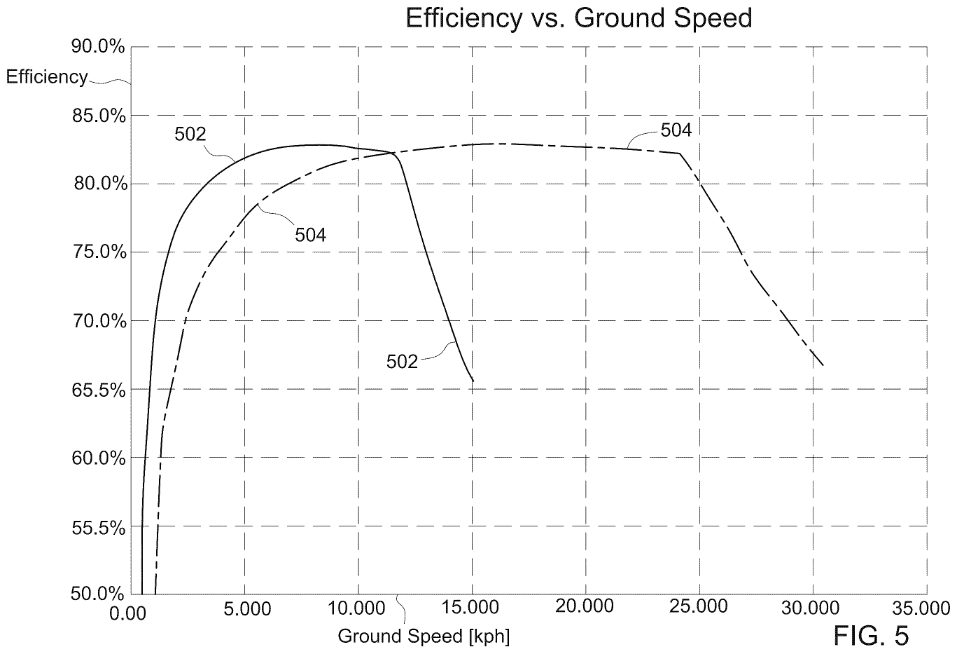

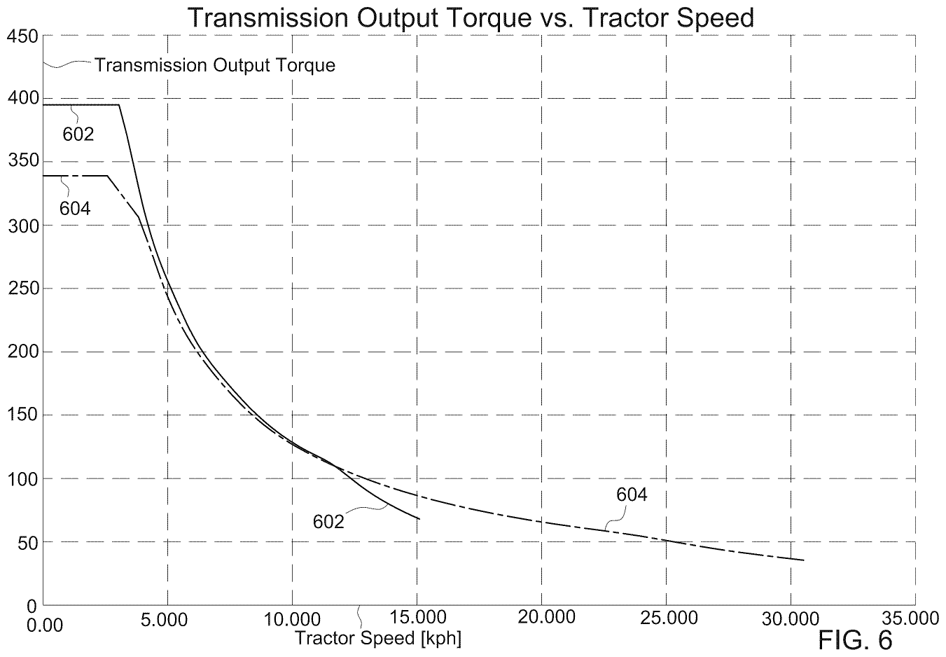

FIGS. 5 and 6 further illustrate how the controller 300 may be configured to shift the transmission 266 between the low speed range and the high speed range at the appropriate ground speed of the working machine 100. FIG. 5 shows in a graphical form the power transmission efficiency of the powertrain 200 as a function of vehicle ground speed in each of the low speed range and the high speed range. A first curve 502 is representative of the transmission efficiency when operating in the low speed range. Second curve 504 is representative of the efficiency when operating in high speed range. As can be seen at ground speeds in the range from zero to about 11.5 kph, the efficiency in the low speed range exceeds that in the high speed range. From a ground speed of about 11.5 kph and above the efficiency in the high speed range greatly exceeds that in the low speed range.

Similarly, FIG. 6 depicts in graphical form the transmission output torque of the powertrain 200 as a function of vehicle ground speed in each of the low speed range and the high speed range. A first curve 602 is representative of the transmission output torque when operating in the low speed range. Second curve 604 is representative of the transmission output torque when operating in high speed range. As can be seen there is a considerable overlap of the transmission output torque values between the low range and the high range from a vehicle speed of about 4.0 kph to a vehicle speed of about 12.0 kph.

This provides a wide range of feasible shift points at vehicle speeds from about 5.0 kph to about 12.0 kph at which the controller 300 may shift the transmission 266 between the low speed range and high speed range with smooth transition and while maintaining operating efficiencies in excess of 80% throughout the operating range of working machine 100.

If the operator directs the working machine 100 to shift into the reverse direction, such as by using operator controls 117, the controller 300 is configured such that to shift the transmission 266 into the reverse range the transmission 266 must first be in the low speed range, and the synchronizer 286 is then moved to a reverse range position to couple the reverse range gearset 278, 280, 282 with the drive shaft 272, 287, and then the first clutch 267 is disengaged and the second clutch 273 is engaged to drive the drive shaft 287 through the reverse range gearset 278, 280, 282. Once again, the rearward advance speed in the reverse speed range is varied by the controller 300 directing the variator 206 to adjust the speed ratio between the variator input 208 and the variator output 210.

Thus, it is seen that with the powertrain architecture disclosed herein, the controller 300 is configured such that the transmission 266 cannot shift directly from the high speed range to the reverse range, but instead the transmission 266 must first shift from the high speed range to the low speed range, and then the transmission 266 may shift to the reverse range.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

1. A working machine, comprising:
a main frame;
a plurality of ground engaging units for supporting the main frame from a ground surface;
a prime mover including a prime mover output, the prime mover includes a single electric machine;
a mechanical variator including a variator input and a variator output;
a direct drive gearset connecting the prime mover output to the variator input and rotating at a speed fixed in proportion to a rotational speed of the prime mover;
a planetary gearset configured to receive a first input from the direct drive gearset and a variable second input from the variator output, and to provide an output drive;
wherein the direct drive gearset further includes:
a first gear attached to the prime mover output;
a second gear attached to an intermediate shaft, the second gear engaging the first gear so that the second gear and the intermediate shaft are driven by the first gear;
a third gear attached to the intermediate shaft so that the second and third gears and the intermediate shaft turn as a unit when driven by the first gear; and
a fourth gear engaging the third gear so that the fourth gear is driven by the third gear, the fourth gear being mounted on a further shaft which is attached to the planetary gearset to provide the first input from the direct drive gearset;
a multi-speed transmission configured to transmit the output drive from the planetary gearset to one or more of the ground engaging units to propel the working machine across the ground surface, the transmission including a low speed range, a high speed range and a reverse range; and
a controller operably connected to the mechanical variator and the multi-speed transmission and configured to control the mechanical variator to vary an advance speed of the working machine, and to control the multi-speed transmission to select between the low speed range, the high speed range and the reverse range;
wherein the multi-speed transmission includes a first clutch connecting the output drive to a low range gearset, and a second clutch connecting the output drive directly to a high range gearset;
wherein the second clutch also connects the output drive directly to a reverse gearset; and
wherein the transmission further includes a synchronizer selectively coupling either the high range gearset or the reverse gearset with a drive shaft connected to the one or more ground engaging units, the drive shaft being separate from the output drive.

2. The working machine of claim 1, further comprising:
at least one auxiliary component driven by the direct drive gearset.

3. The working machine of claim 2, wherein:
the at least one auxiliary component includes a hydraulic pump.

4. The working machine of claim 2, wherein:
the at least one auxiliary component includes a power take-off.

5. The working machine of claim 4, further comprising:
a clutch between the direct drive gearset and the power take-off.

6. The working machine of claim 1, wherein:
the planetary gearset includes a sun gear, a plurality of planet gears carried by a carrier, and a ring gear;
the direct drive gearset drives the sun gear;
the variator output drives the carrier; and
the ring gear drives the output drive.

7. (canceled)

8. (canceled)

9. The working machine of claim 1, wherein:
the controller is configured such that when shifting the transmission from the low speed range to the high speed range the synchronizer is first moved to a high range position to couple the high range gearset with the drive shaft, and then the first clutch is disengaged and the second clutch is engaged to drive the drive shaft through the high range gearset.

10. The working machine of claim 1, wherein:
the controller is configured such that to shift the transmission into the reverse range the transmission must first be in the low speed range, and the synchronizer is then moved to a reverse range position to couple the reverse range gearset with the drive shaft, and then the first clutch is disengaged and the second clutch is engaged to drive the drive shaft through the reverse range gearset.

11. The working machine of claim 1, wherein:
the controller is configured such that the transmission cannot shift directly from the high speed range to the reverse range, but instead the transmission must first shift from the high speed range to the low speed range, and then the transmission may shift to the reverse range.

12. The working machine of claim 1, wherein:
the one or more ground engaging units driven by the transmission includes first and second rear ground engaging units and first and second front ground engaging units;
the transmission always drives the first and second rear ground engaging units when propelling the working machine across the ground surface; and
the working machine further includes a front drivetrain including a further clutch for selectively coupling the transmission to the first and second front ground engaging units so that the working machine selectively drives all four ground engaging units.

13. The working machine of claim 1, wherein:
the working machine is a compact utility tractor.

14. The working machine of claim 1, wherein:
the mechanical variator is a toroidal CVT.

15. A compact utility tractor, comprising:
a main frame;
first and second rear ground engaging units and first and second front ground engaging units for supporting the main frame from a ground surface;
a prime mover including a prime mover output, the prime mover including a single electric machine;
a mechanical variator including a variator input and a variator output;
a direct drive gearset connecting the prime mover output to the variator input and rotating at a speed fixed in proportion to a rotational speed of the prime mover;
a hydraulic pump driven by the direct drive gearset;
a power take-off driven by the direct drive gearset;
a power take-off clutch between the direct drive gearset and the power take-off:
a planetary gearset configured to receive a first input from the direct drive gearset and a variable second input from the variator output, and to provide an output drive, wherein the planetary gearset includes a sun gear, a plurality of planet gears carried by a carrier, and a ring gear, wherein the direct drive gearset drives the sun gear, wherein the variator output drives the carrier, and wherein the ring gear drives the output drive;
a multi-speed transmission configured to transmit the output drive from the planetary gearset to one or more of the ground engaging units to propel the compact utility tractor across the ground surface, the transmission including a low speed range, a high speed range and a reverse range, wherein the transmission always drives the first and second rear ground engaging units when propelling the compact utility tractor across the ground surface, wherein the transmission includes:
a first clutch connecting the output drive to a low range gearset;
a second clutch connecting the output drive directly to a high range gearset and connecting the output drive directly to a reverse gearset; and
a synchronizer selectively coupling either the high range gearset or the reverse gearset with a drive shaft connected to the one or more ground engaging units, the drive shaft being separate from the output drive;
a front drivetrain including a further clutch for selectively coupling the transmission to the first and second front ground engaging units so that the compact utility tractor selectively drives all four ground engaging units; and
a controller operably connected to the mechanical variator and the multi-speed transmission and configured to control the mechanical variator to vary an advance speed of the compact utility tractor, and to control the multi-speed transmission to select between the low speed range, the high speed range and the reverse range, the controller being configured such that:
when shifting the transmission from the low speed range to the high speed range the synchronizer is first moved to a high range position to couple the high range gearset with the drive shaft, and then the first clutch is disengaged and the second clutch is engaged to drive the drive shaft through the high range gearset; and
to shift the transmission into the reverse range the transmission must first be in the low speed range, and the synchronizer is then moved to a reverse range position to couple the reverse range gearset with the drive shaft, and then the first clutch is disengaged and the second clutch is engaged to drive the drive shaft through the reverse range gearset;
wherein the direct drive gearset further includes:
a first gear attached to the prime mover output;
a second gear attached to an intermediate shaft, the second gear engaging the first gear so that the second gear and the intermediate shaft are driven by the first gear;
a third gear attached to the intermediate shaft so that the second and third gears and the intermediate shaft turn as a unit when driven by the first gear; and
a fourth gear engaging the third gear so that the fourth gear is driven by the third gear, the fourth gear being mounted on a further shaft which is attached to the sun gear of the planetary gearset so that the direct drive gearset drives the sun gear.

16. (canceled)

17. The compact utility tractor of claim 15, wherein:
the intermediate shaft extends through the mechanical variator and is connected to the power take-off through the power take-off clutch on an opposite side of the mechanical variator from the second and third gears.

18. The compact utility tractor of claim 15, wherein:
the hydraulic pump is driven by a further plurality of gears one of which engages and is driven by the fourth gear.
